(19) United States
(12) Patent Application Publication
(10) Pub. No.: US 2015/0012747 A1
(43) Pub. Date: Jan. 8, 2015

(54) METHOD AND APPARATUS FOR APPLYING ENCRYPTION IN COMMUNICATION BETWEEN TERMINALS

(71) Applicant: Samsung Electronics Co., Ltd., Gyeonggi-do (KR)

(72) Inventor: Woojun Choi, Gyeonggi-do (KR)

(21) Appl. No.: 14/326,394

(22) Filed: Jul. 8, 2014

(30) Foreign Application Priority Data
Jul. 8, 2013 (KR) 10-2013-0079464

(51) Int. Cl. H04L 29/06

(52) U.S. Cl. CPC H04L 63/0428
USPC 713/168

(57) ABSTRACT

A method for applying encryption in communication between terminals includes determining a security key to be used when the terminal transmits and receives data to/from another terminal, determining information for updating the security key; transmitting a signal including information related to the security key and the information for updating the security key, to the another terminal, and encrypting data to be transmitted to the another terminal or decrypting data received from the another terminal, by using the security key. A security key is configured during communication between terminals, and is updated without separate communication between the terminals. Encryption and decryption are performed during transmission and reception of data. Therefore, security can be secured at relatively low complexity during the transmission and reception of data between the terminals. Other embodiments including a terminal are also disclosed.

### CROSS-REFERENCE TO RELATED APPLICATION AND CLAIM OF PRIORITY

The present application is related to and claims priority from and the benefit under 35 U.S.C. §119(a) of Korean Patent Application No. 10-2013-0079464, filed on Jul. 8, 2013, which is hereby incorporated by reference for all purposes as if fully set forth herein.

### TECHNICAL FIELD

The present disclosure relates generally to a method and an apparatus for applying encryption in communication between terminals. More particularly, the present disclosure relates to a method and an apparatus for applying encryption and improving security during transmission and reception of data between users in the case of communication between terminals, which includes a Rich Communication Service (RCS).

### BACKGROUND

There are many cases, to which encryption is not applied when data is transmitted and received between conventional terminals. In contrast, even when encryption is applied, data is transmitted and received between higher network layers through encryption while the data is transmitted and received therebetween, and each of the conventional terminals receives decrypted data. Accordingly, it is problematic in that the contents of the data are exposed. Also, with the advancement of technologies, a large amount of data that an individual has is frequently transmitted and received due to an increase in bandwidth during communication. In this regard, there is a need for an encryption method having low complexity.

Further, when an RCS function including an Instant Messaging (IM) service or a file sharing service is used between terminals, security keys for encryption are exchanged whenever data is transmitted and received, or a security key is used which is based on personal information according to a user's input. As a result, it is disadvantageous in that security is reduced. Moreover, when a security key is leaked, if the user does not change the security key, a problem arises in that it is apprehended that transmitted/received data will be continuously exposed to unauthorized persons. Therefore, there is a need for a method and an apparatus for providing more reliable encryption when data is transmitted and received between terminals.

### SUMMARY

To address the above-discussed deficiencies, it is a primary object to provide a method and an apparatus which configure a security key between terminals in order to transmit and receive data therebetween, encrypt data by using the configured security key, transmit the encrypted data, and decrypt the received data by using the configured security key.

Also, another embodiment of the present disclosure provides a method and an apparatus which can periodically change a security key to be applied when data is transmitted and received between terminals and enable each terminal to update a security key associated with a counterpart terminal without separate communication between the terminals.

In accordance with an aspect of the present disclosure, a method for transmitting and receiving data by a terminal is provided. The method includes determining a security key to be used when the terminal transmits and receives data to/from a particular terminal, determining information for updating the security key, transmitting a signal including information related to the security key and the information for updating the security key, to the particular terminal, and encrypting data to be transmitted to the particular terminal or decrypting data received from the particular terminal, by using the security key.

In accordance with another aspect of the present disclosure, a terminal for transmitting and receiving data is provided. The terminal includes a transceiver capable of transmitting and receiving data to/from another terminal, and a controller for controlling the transceiver, dete a security key to be used when the terminal transmits and receives data to/from a particular terminal, determining information for updating the security key, transmitting a signal including information related to the security key and the information for updating the security key to the particular terminal, and encrypting data to be transmitted to the particular terminal or decrypting data received from the particular terminal, by using the security key.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of a terminal according to an embodiment of the present disclosure;

FIG. 2 is a signal flow diagram illustrating a method for configuring a security key between terminals according to an embodiment of the present disclosure;

FIG. 3 is a flowchart illustrating a method for configuring a security key by a first terminal according to an embodiment of the present disclosure;

FIG. 4 is a flowchart illustrating a method for configuring a security key by a second terminal according to an embodiment of the present disclosure;

FIG. 5 is a flowchart illustrating a method for updating a security key by a terminal according to an embodiment of the present disclosure;

FIG. 6 is a flowchart illustrating a method for applying encryption and decryption when data is transmitted and received between terminals, according to an embodiment of the present disclosure; and

FIG. 7 is a signal flow diagram illustrating a method for configuring a security key between terminals according to another embodiment of the present disclosure.

### DETAILED DESCRIPTION

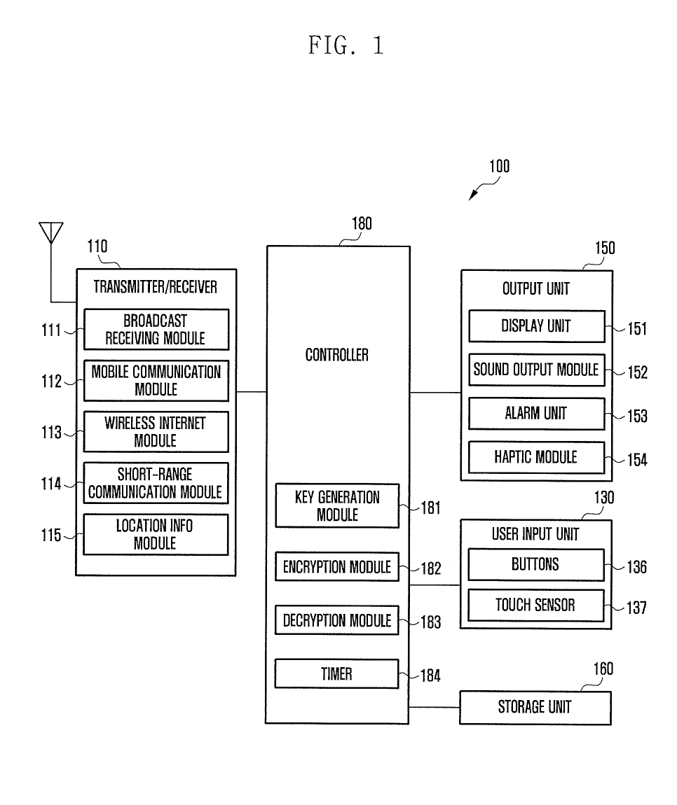

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged telecommunication technologies. Hereinafter, preferred embodiments of the present disclosure will be described in detail with reference to the accompanying drawings.

In describing the exemplary embodiments of the present disclosure, descriptions related to technical contents which are well-known in the art to which the present disclosure pertains, and are not directly associated with the present disclosure, will be omitted. Such an omission of unnecessary descriptions is intended to prevent obscuring of the main idea of the present disclosure and more clearly transfer the main idea.

For the same reason, in the accompanying drawings, some elements may be exaggerated, omitted, or schematically illustrated. Further, the size of each element does not entirely reflect the actual size. In the drawings, identical or corresponding elements are provided with identical reference numerals.

Here, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” or “module” refers to a software element or a hardware element, such as a Field Programmable Gate Array (FPGA) or an Application Specific Integrated Circuit (ASIC), which performs a predetermined function. However, the “unit” or “module” does not always have a meaning limited to software or hardware. The “unit” or “module” may be constructed either to be stored in an addressable storage medium or to execute one or more processors. Therefore, the “unit” or “module” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” or “module” may be either combined into a smaller number of elements, “unit”, or “module” or divided into a larger number of elements, “unit”, or “module”. Moreover, the elements and “units” or “modules” may be implemented to reproduce one or more CPUs within a device or a security multimedia card.

An electronic device described in this specification can include one or more of a mobile phone, a smart phone, a laptop computer, a user electronic device for digital broadcasting, a Personal Digital Assistant (PDA), a Portable Multimedia Player (PMP), and a navigation device. However, it can be easily understood by those skilled in the art in the technical field of the present disclosure that a configuration according to embodiments described in this specification can be applied to a fixed user electronic device (e.g., a digital Television (TV), a desktop computer, etc.) except for a case of being applicable to only the user electronic device.

FIG. 1 is a block diagram illustrating a configuration of a user electronic device related to an embodiment of the present disclosure. In an embodiment of the present disclosure, the user electronic device can be referred to as a “terminal.”

Referring to FIG. 1, the terminal 100 can include one or more of a transmitter/receiver 110, a user input unit 130, an output unit 150, a storage unit 160, and a controller 180. The elements illustrated in FIG. 1 may not be essential. Accordingly, the terminal can be implemented so as to include more elements than those illustrated in FIG. 1, or can be implemented so as to include fewer elements than those illustrated in FIG. 1.

Hereinafter, the elements will be sequentially described.

The transmitter/receiver 110 can include one or more modules which enable wireless communication between the terminal 100 and a wireless communication system or between the terminal 100 and a network in which the terminal 100 is located. For example, the transmitter/receiver 110 can include a broadcast receiving module 111, a mobile communication module 112, a wireless Internet module 113, a short-range communication module 114, a location information module 115, and the like.

The broadcast receiving module 111 receives a broadcast signal and/or broadcast-related information from an external broadcast management server through a broadcast channel. Examples of the broadcast channel can include a satellite channel and a terrestrial channel. In order to perform simultaneous broadcast reception or broadcast channel switching with respect to at least two broadcast channels, two or more broadcast receiving modules can be provided to the mobile terminal 100.

The broadcast management server can refer to a server which generates and transmits a broadcast signal and/or broadcast-related information, or a server which is provided with previously-generated broadcast signals and/or broadcast-related information and transmits the same to the terminal. Examples of the broadcast signal can include not only a TV broadcast signal, a radio broadcast signal and a data broadcast signal, but also a broadcast signal in the form of a combination of a TV broadcast signal or a radio broadcast signal with a data broadcast signal.

The broadcast-related information refers to information related to a broadcast channel, a broadcast program, or a broadcast service provider. The broadcast-related information can also be provided through a mobile communication network. In this case, the broadcast-related information can be received by the mobile communication module 112.

The broadcast-related information can exist in various forms. For example, the broadcast-related information can exist in the form of an Electronic Program Guide (EPG) of Digital Multimedia Broadcasting (DMB), an Electronic Service Guide (ESG) of Digital Video Broadcast-Handheld (DVB-H), or the like.

The broadcast receiving module 111, for example, can receive a digital broadcast signal by using a digital broadcasting system, such as Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Convergence of Broadcasting and Mobile Service (DVB-CBMS), Open Mobile Alliance-BroadCAST (OMA-BOAST), China Multimedia Mobile Broadcasting (CMMB), Mobile Broadcasting Business Management System (MBBMS), Integrated Services Digital Broadcast-Terrestrial (ISDB-T), and the like. It goes without saying that the broadcast receiving module 111 can be configured to be appropriate for another broadcasting system as well as the above-described digital broadcasting systems.

A broadcast signal and/or broadcast-related information received through the broadcast receiving module 111 can be stored in the storage unit 160.

The mobile communication module 112 transmits and receives a wireless signal to/from at least one of a base station, an external terminal and a server in a mobile communication network, such as Global System for Mobile communications (GSM), Code Division Multiple Access (CDMA), and Wideband CDMA (WCDMA) (not limited thereto). The wireless signal can include a voice call signal, a video call signal, or data in various forms according to the transmission and reception of text/multimedia messages.

The wireless Internet module 113 can refer to a module for wireless Internet connection, and can be mounted inside or outside the terminal 100. Use can be made of wireless Internet technologies, such as Wireless Local Area Network (WLAN) (i.e., Wi-Fi), Wireless broadband (Wibro), World Interoperability for Microwave Access (Wimax), High Speed Downlink Packet Access (HSDPA), GSM, CDMA, WCDMA, Long Term Evolution (LTE) (not limited thereto), and the like.

From a viewpoint such that a wireless Internet connection according to Wibro, HSDPA, GSM, CDMA, WCDMA, LTE, and the like is made through a mobile communication network, the wireless Internet module 113 which performs a wireless Internet connection through the mobile communication network can be understood as a kind of the mobile communication module 112.

The short-range communication module 114 refers to a module for short-range communication. Use can be made of short-range communication technologies, such as Bluetooth, Radio Frequency Identification (RFID), Infrared Data Association (IrDA), Ultra Wideband (UWB), ZigBee, and the like.

The location information module 115 refers to a module for acquiring a location of the terminal, and a typical example thereof can include a Global Positioning System (GPS) module. According to the current technology, the location information module 115 calculates information on a distance between the terminal and each of three or more satellites and information on an accurate time point at which the distance information has been measured, applies trigonometry to the calculated distance information and time information, and thereby can accurately calculate three-dimensional (3D) current location information according to latitude, longitude and altitude. Currently, a method has been widely used for calculating location and time information by using three satellites and correcting errors of the calculated location and time information by using another satellite. Also, the location information module 115 can calculate speed information by continuously calculating a current location of the terminal in real time.

The user input unit 130 generates input data for controlling an operation of the terminal by a user. The user input unit 130 can include buttons 136 disposed on a front surface, a rear surface, or a lateral surface of the mobile terminal 100, and a touch sensor (static pressure/capacitance) 137, and although not illustrated, can include a keypad, a dome switch, a jog wheel, a jog switch, and the like.

The output unit 150 generates an output related to the sense of sight, the sense of hearing, the sense of touch, or the like, and can include a display unit 151, a sound output module 152, an alarm unit 153, a haptic module 154, and the like.

The display unit 151 displays (i.e., outputs) information processed by the terminal 100. For example, when the terminal 100 is in a call mode, the display unit 151 displays a User Interface (UI) or a Graphical UI (GUI) related to a call. When the terminal 100 is in a video call mode or in an image capturing mode, the display unit 151 displays a captured and/or received image, a UI, or a GUI.

The display unit 151 can include at least one of a Liquid Crystal Display (LCD), a Thin Film Transistor-Liquid Crystal Display (TFT LCD), an Organic Light-Emitting Diode (OLED) display, a flexible display, and a 3D display.

Some of the displays can be implemented in a transparent type or a light transmission type so that the outside can be seen therethrough. These displays can be referred to as transparent displays. A typical example of the transparent display can be a Transparent OLED (TOLED), and the like. A rear structure of the display unit 151 can also be of the light transmission type. This structure enables the user to see an object, which is located in the rear of a body of the terminal, through an area of the body of the terminal, which is occupied by the display unit 151.

The terminal 100 can include two or more display units 151 according to an implementation form thereof. For example, multiple display units can be disposed to be spaced apart from each other or to be integrated with each other on one surface of the terminal 100, or can be disposed on different surfaces of the terminal 100, respectively.

When the display unit 151 and the touch sensor 137 form a layer structure or are formed to be integrated with each other (hereinafter referred to as a “touch screen”), the display unit 151 can be used as an input device as well as an output device. When the touch sensor 137 has a form (e.g., a touch film, a touch sheet, a touch pad, etc.), the touch sensor 137 can be formed in a layer structure by being layered on the display unit 151, and can be formed to be integrated by being included in the configuration of the display unit 151.

The touch sensor 137 can be configured to convert a pressure applied to a particular part of the display unit 151 or a change in capacitance and the like generated at the particular part thereof, into an electrical input signal. The touch sensor 137 can be configured to detect not only a touched location and a touched area but also a pressure at the time of the touch.

When the touch sensor 137 senses a touch input, signal(s) corresponding to the touch input is delivered to a touch controller (not illustrated). The touch controller processes the received signal(s), and delivers corresponding data to the controller 180. Accordingly, the controller 180 can determine which area of the display unit 151 has been touched, etc., based on the received data.

Hereinafter, for convenience of description, an action of causing a pointer to be recognized as being located to be in close proximity to a touch screen without contacting the touch screen can be referred to as a “proximity touch.” An action of causing the pointer to actually contact the touch screen can be referred to as a “contact touch.” A position at which a proximity touch of the pointer occurs on the touch screen can refer to a position at which the pointer faces perpendicular to the touch screen when the proximity touch of the pointer occurs.

The proximity sensor can sense the proximity touch and a proximity touch pattern. Here, examples of the proximity touch pattern can include a proximity touch distance, a proximity touch direction, a proximity touch velocity, a proximity touch time period, a proximity touch position, a proximity touch moving state, and the like. Information corresponding to the sensed proximity touch action and proximity touch pattern can be displayed on the touch screen.

The sound output module 152 can output audio data received from the transmitter/receiver 110 or stored in the storage unit 160, in a call signal reception mode, a telephone call mode, a recording mode, a voice recognition mode, a broadcast reception mode, and the like. The sound output module 152 can output a sound signal related to a function (e.g., a call signal reception sound, a message reception sound, etc.) performed by the terminal 100. The sound output module 152 can include a receiver, a speaker, a buzzer, and the like.

The alarm unit 153 outputs a signal for notifying of occurrence of an event from the terminal 100. Examples of the event occurring in the terminal 100 can include reception of a call signal, reception of a message, input of a key signal, input of a touch, and the like. The alarm unit 153 can output not only a video signal or an audio signal, but also other types of signals, for example, a signal for notifying of occurrence of an event through vibration. The video signal or the audio signal can also be output from the display unit 151 or the voice output module 152. Accordingly, in this case, the display unit 151 and the voice output module 152 can be classified as a kind of alarm unit 153.

The haptic module 154 generates various tactile effects that the user can feel. A typical example of the tactile effects generated by the haptic module 154 includes vibration. It is possible to control the intensity, pattern, and the like of vibration generated by the haptic module 154. For example, different vibrations can be output after being combined, or can be sequentially output.

The haptic module 154 can generate various tactile effects, including not only vibration, but also an effect of stimulus according to the arrangement of pins vertically moving with respect to a skin surface being contacted, an effect of stimulus according to a jet force or suction force of air through an injection hole or a suction hole, an effect of stimulus of touching a skin surface, an effect of stimulus according to contact of an electrode, an effect of stimulus using an electrostatic force and the like, an effect according to the reproduction of a cool or warm feeling using an element capable of absorbing or radiating heat, and the like.

The haptic module 154 can be implemented not only to deliver a tactile effect through direct contact, but also to enable the user to feel a tactile effect through a kinesthetic sense of the user's finger, arm, and the like. The terminal 100 can include two or more haptic modules 154 according to a configuration of the terminal 100.

The storage unit 160 can store programs for processing and control performed by the controller 180, or can temporarily store input/output data (e.g., a phone book, a message, audio, a still image, a moving image, etc.). The storage unit 160 can store the frequency of use of each data (e.g., the frequency of use of each phone number, that of use of each message, and that of use of each multimedia).

Also, the storage unit 160 can store data on vibrations and sounds of various patterns, which are output when a touch is input to the touch screen.

The storage unit 160 can include a storage medium of at least one type from among a flash memory type, a hard disk type, a multimedia card micro type, a card-type memory (e.g., a Secure Digital (SD) memory, an eXtreme Digital (XD) memory, etc.), a Random Access Memory (RAM), a Static RAM (SRAM), a Read-Only Memory (ROM), an Electrically Erasable PROM (EEPROM), a Programmable ROM (PROM), a magnetic memory, a magnetic disk, and an optical disk. The terminal 100 can also operate in relation to a web storage which performs a storage function of the storage unit 160 on the Internet.

The controller 180 typically controls an overall operation of the terminal 100. For example, the controller 180 performs control and processing, which are related to voice communication, data communication, video communication, and the like. The controller 180 can include a multimedia module for reproducing multimedia. The multimedia module can be implemented within the controller 180, or can be implemented separately from the controller 180.

The controller 180 can perform a pattern recognition processing capable of recognizing a handwriting input or a picture-drawing input, which is received through the touch screen, as a character and an image, respectively.

The various embodiments described herein can be implemented in, for example, a recording medium readable by a computer or an apparatus similar to the computer by using software, hardware, or some combinations thereof.

The controller 180 can include one or more of a key generation module 181, an encryption module 182, a decryption module 183, and a timer 184.

The key generation module 181 can generate a unique key for encryption. More specifically, the key generation module 181 can generate a key for encryption based on a character string. The character string can include one or more of a number and a special symbol, and the key generation module 181 can generate an identical unique key with respect to an identical character string. According to an embodiment of the present disclosure, the key generation module 181 can generate a unique key of a particular length. Typically, a character string used to generate a unique key may not be found based on the unique key generated by the key generation module 181. According to an embodiment of the present disclosure, the key generation module 181 can generate a unique key based on a current time value. Accordingly, when knowing an identical time value or an identical time range value even without separate communication, the key generation module 181 generated by using an identical algorithm can generate an identical unique key. According to an embodiment of the present disclosure, a character string that the key generation module 181 uses in order to generate a unique key can be referred to as a “source character string.”

The encryption module 182 can encrypt data that the terminal 100 transmits and receives or stores. More specifically, the encryption module 182 can encrypt data based on a unique key generated by the key generation module 181. One or more of Advanced Encryption Standard (AES), Data Encryption Standard (DES), Triple DES (3DES), Wired Equivalent Privacy (WEP), Temporal Key Integrity Protocol (TKIP), SEED, and Academy Research Institute Agency (ARIA) can be used as an encryption algorithm. In embodiments of the present disclosure, an encryption algorithm of each type can be used regardless of the embodiments of the present disclosure. In the case of encrypted data generated based on a unique key, if the encryption module 182 knows the unique key, the encryption module 182 can decrypt the encrypted data. In embodiments of the present disclosure, when the encrypted data is transmitted and received, the transmitted/received data can include the type of an encryption algorithm used for the encrypted data, in a form such as a header.

The decryption module 183 can decrypt the encrypted data that the terminal 100 transmits and receives or stores. More specifically, the decryption module 183 can decrypt the encrypted data based on an encrypted unique key. In embodiments of the present disclosure, the encrypted data received by the terminal 100 can include a header in which an algorithm of the encryption is specified. The decryption module 183 can decrypt the encrypted data based on a stored or generated unique key. Data after being decrypted is identical to data before being encrypted. When the decryption fails, the decryption module 183 can detect the failure of the decryption. Alternatively, the decryption module 183 can again attempt decryption based on another unique key.

The timer 184 can measure a lapse of time, and can provide a current time point to the terminal 100. In embodiments of the present disclosure, the key generation module 181 can generate a unique key based on a time point provided by the timer 184. Also, when an elapsed time value measured by the timer 184 exceeds a particular value, the key generation module 181 can generate a new unique key. When the new unique key is generated, a new time value can be utilized as a source character string.

For hardware implementation, the embodiments described herein can be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, and other electrical units for executing functions. In some cases, the embodiments described in this specification can be implemented by the controller 180 itself.

For software implementation, the embodiments such as procedures and functions described in this specification can be implemented by separate software modules. Each of the software modules can perform one or more functions and operations described in this specification. A software code can be implemented by a software application written in an appropriate programming language. The software code can be stored in the storage unit 160, and can be executed by the controller 180.

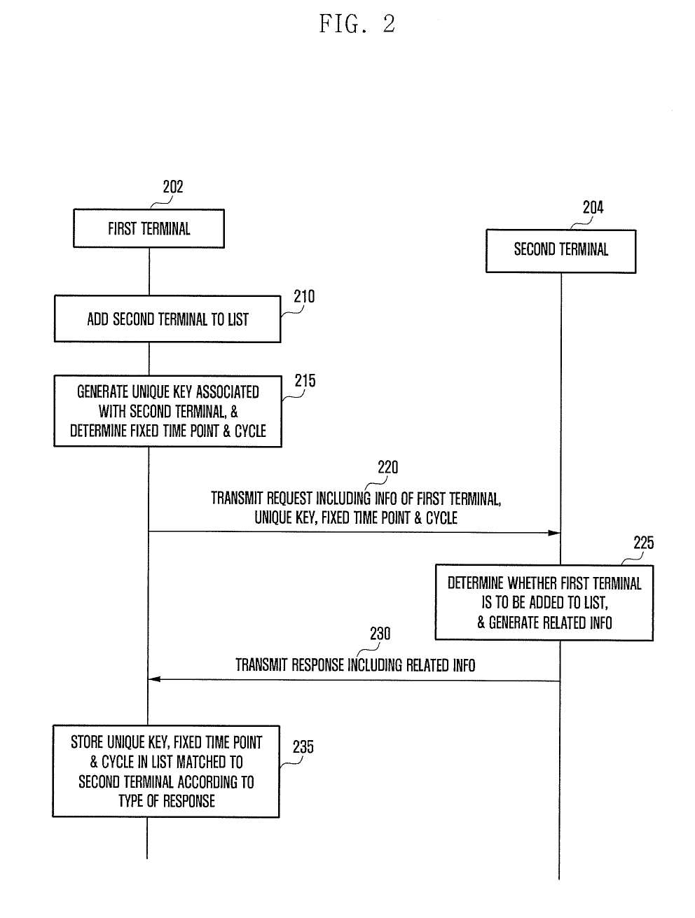

FIG. 2 is a signal flow diagram illustrating a method for configuring a security key between terminals according to an embodiment of the present disclosure. In an embodiment of the present disclosure, it is possible to use a security key mixed with a unique key.

Referring to FIG. 2, in an embodiment of the present disclosure, each of a first terminal 202 and a second terminal 204 can store a security key associated with a counterpart terminal.

In step 210, the first terminal 202 can add the second terminal 204 to a list. According to an embodiment of the present disclosure, the list can have a concept identical to that of an address book. When the first terminal 202 transmits and receives data to/from the second terminal 204 by using a particular application, the list can be a user list of the particular application. The particular application can include an application providing a Rich Communication Service (RCS).

In step 215, the first terminal 202 can determine the generation of a security key to be used for encryption/decryption when transmitting and receiving data to/from the second terminal 204 after adding the second terminal 204 to the list. The generation of the security key can be determined according to the setting of the particular application. Also, the security key can be used for a unique function configured for each terminal. As described above, the present disclosure has a technical feature in that each terminal is capable of configuring a security key in order to transmit and receive data to/from another terminal. More specifically, in an embodiment of the present disclosure, the first terminal 202 can generate or determine one or more of a security key, a fixed time point and a cycle, which are to be used to communicate with the second terminal 204. In an embodiment of the present disclosure, the fixed time point can be related to a time point of generating the security key. Also, the fixed time point can be used as a reference time point for updating a security key. The cycle can be a cycle time for updating the security key. More specifically, according to an embodiment of the present disclosure, the first terminal 202 can have time values including one or more of 10 minutes, 1 hour, 6 hours and 1 day. The cycle time can be determined by a setting of the user or a value previously set for the first terminal 202. Thereafter, the first terminal 202 can update the security key whenever the cycle time elapses from the fixed time point. The security key can be updated by generating a new security key by using a source character string determined based on a time point value updated by the key generation module 181. Further, according to an embodiment of the present disclosure, the fixed time point can be a particular time point value, and the security key can be updated whenever the cycle time elapses from the particular time point. Accordingly, when the fixed time point is set to a particular value between the first terminal 202 and the second terminal 204 in the previous step, the security key can be updated without transmitting and receiving the fixed time point between the first terminal 202 and the second terminal 204.

In step 220, the first terminal 202 can transmit, to the second terminal 204, a request including one or more of the security key, the fixed time point and the cycle time, which have been generated in step 215, together with information of the first terminal. The request can notify the second terminal 204 that the first terminal 202 can add the second terminal 204 to the list, can encrypt data based on the security key and can transmit the encrypted data during the subsequent transmission and reception, and can decrypt the encrypted data by using the security key. Also, according to an embodiment of the present disclosure, the first terminal 202 can transmit a source character string used to generate the security key instead of transmitting the security key. When the source character string is transmitted as described above, a terminal which does not have a key generation module identical to that of each of the first terminal 202 and the second terminal 204 has an effect such that the terminal cannot generate a security key even when a source character string is found.

In step 225, the second terminal 204 can determine whether the first terminal 202 is to be added to a list, based on the request received in step 220. Also, according to the determination, the second terminal 204 can generate related information. More specifically, the related information can include the information of the first terminal 202. When the second terminal 204 desires to configure a different time update cycle, the related information can include information making a request for changing the time update cycle.

In step 230, the second terminal 204 can transmit, to the first terminal 202, a response including a result of the determination and the generated related information in step 225.

In step 235, the first terminal 202 can store one or more of a security key, a fixed time point and a cycle time in a list matched to the second terminal 204, according to the type of the response received in step 230. Then, each of the first terminal 202 and the second terminal 204 can encrypt data based on the determined security key and can transmit the encrypted data during transmission and reception of data, and can decrypt the received data. In an embodiment of the present disclosure, the first terminal 202 and the second terminal 204, each of which is a main entity for determining the security key, the fixed time point and the cycle time, can selectively determine the security key, the fixed time point and the cycle time. Specifically, an embodiment of the present disclosure can be implemented in a form such that the first terminal 202 determines some of the security key, the fixed time point and the cycle time, and the second terminal 204 determines the rest.

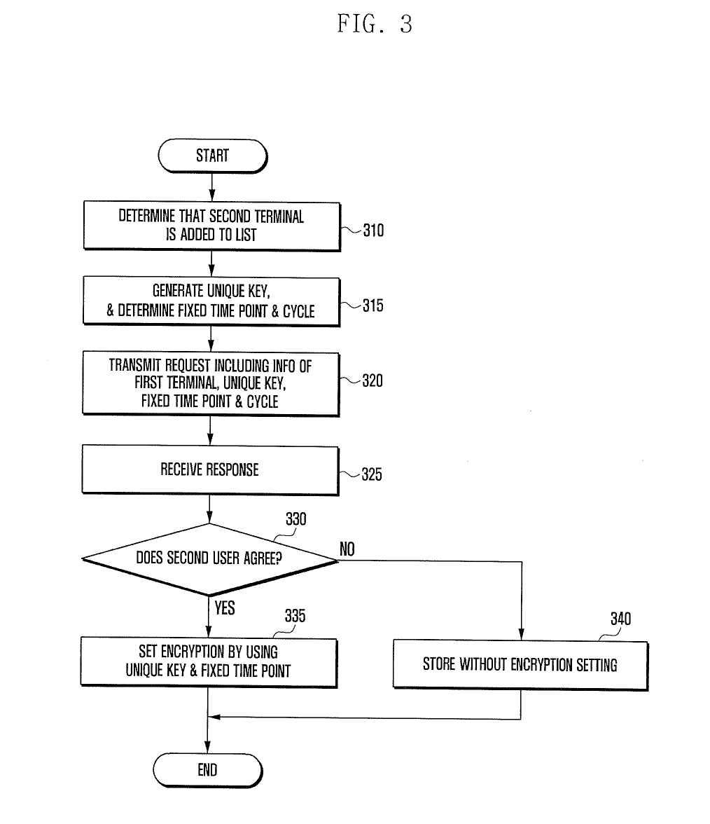

FIG. 3 is a flowchart illustrating a method for configuring a security key by a first terminal according to an embodiment of the present disclosure.

Referring to FIG. 3, in step 310, the first terminal can determine that the second terminal is added to a list. According to an embodiment of the present disclosure, the determination is made as to adding the second terminal by the user, and can also be performed by an input from an input unit of the first terminal. Also, according to an embodiment of the present disclosure, the method can further include a step of determining whether data is to be encrypted by using a security key through an additional input by the user when the first terminal subsequently transmits and receives the data to/from the second terminal.

In step 315, the first terminal can generate a security key, and can determine one or more values of a fixed time point and a cycle. The security key can be generated by the key generation module based on a time point value used to generate the security key. The key generation module can add an identifier value of the first terminal to the time point value, and can generate the security key based on the time point value to which the identifier value of the first terminal is added. The fixed time point can be a value related to the time point value used to generate the security key, and can be used as a reference time point, when the security key is subsequently updated. Also, a cycle time can be used to update the security key.

In step 320, the first terminal can transmit, to the second terminal, a request including one or more of the information of the first terminal and the values determined or generated in step 315. The request can be a request for storing the first terminal in a list including contacts and transmitting/receiving data by using the security key when a signal is subsequently transmitted and received, which is sent to the second terminal.

In step 325, the first terminal can receive a response from the second terminal. In step 330, according to the type of the response, the first terminal can determine whether a user of the second terminal agrees with the request. When the user of the second terminal agrees with the request, in step 335, the first terminal can store the values, which have been generated or determined in step 315, in a list matched to the second terminal, and can proceed with an encryption setting. Then, the first terminal can encrypt data to be transmitted to the second terminal by using the security key, and can decrypt data received from the second terminal by using the security key.

When the user of the second terminal does not agree with the request in step 330, in step 340, the first terminal can add the second terminal to a list without the encryption setting.

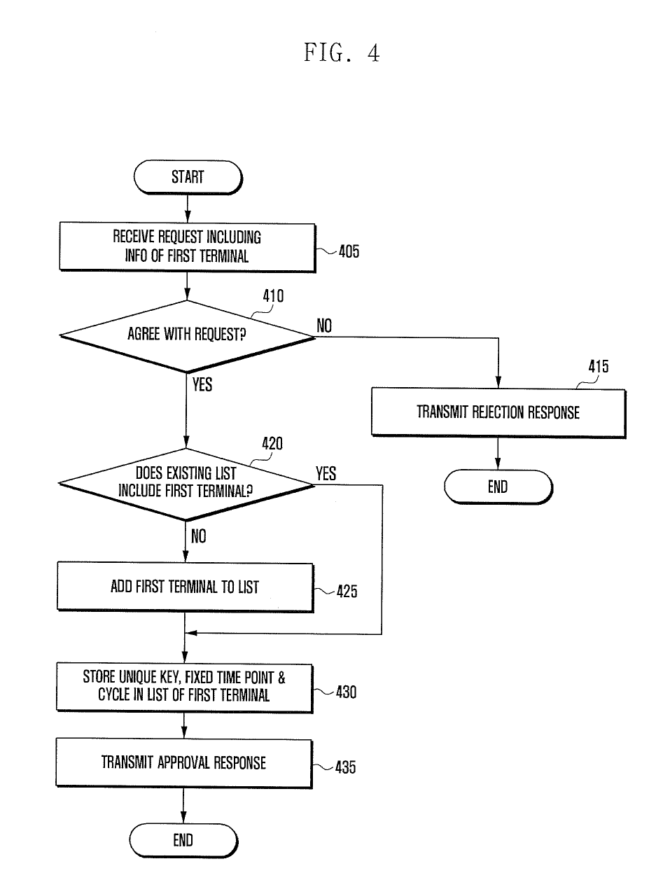

FIG. 4 is a flowchart illustrating a method for configuring a security key by a second terminal according to an embodiment of the present disclosure.

Referring to FIG. 4, in step 405, the second terminal can receive a request including the information of the first terminal. More specifically, the request can include one or more of a unique key, a fixed time point and a cycle time, which have been generated by the first terminal.

In step 410, the second terminal can determine whether the second terminal agrees with the request received in step 405. The determination can be made according to an input by the user of the second terminal.

When the second terminal does not agree with the request, in step 415, the second terminal can transmit a rejection response to the first terminal.

When the second terminal agrees with the request, in step 420, the second terminal can determine whether an existing list includes information matched to the first terminal.

When the existing list does not include the information matched to the first terminal, in step 425, the second terminal can add information including the information of the first terminal, to the list.

In step 430, the second terminal can store one or more of the security key, the fixed time point and the cycle time, which have been received in step 405, in a list of the first terminal.

In step 435, the second terminal can transmit an approval response to the first terminal.

According to an embodiment of the present disclosure, the operation in step 435 can be performed in any one of a step, which precedes step 420, to step 430.

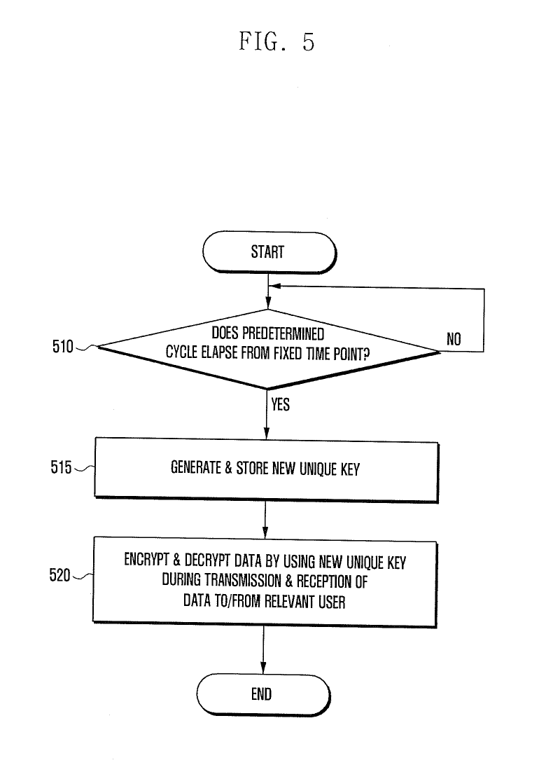

FIG. 5 is a flowchart illustrating a method for updating a security key by a terminal according to an embodiment of the present disclosure. The method for updating a security key can be performed by one or more of the first terminal and the second terminal.

Referring to FIG. 5, in step 510, the terminal can determine whether a predetermined cycle elapses from a fixed time point. The fixed time point can be related to a time point of generating a first security key, and the cycle time is a value determined according to an input by the user or the setting of the terminal. When the cycle time does not elapse from the fixed time point, the terminal does not continuously perform a separate operation, and can perform one or more of encryption and decryption while continuing to use the existing security key.

When the cycle time elapses from the fixed time point, in step 515, the terminal can generate and store a new security key. The new security key can be generated by the key generation module of the terminal. The key generation module can generate a security key based on a value related to a time point value used to generate the new security key.

In step 520, the terminal can encrypt and decrypt data by using the new security key generated in step 515, when the terminal transmits and receives data to/from the user who uses the new security key.

As described above, there is an effect such that a security key can be updated even without separate communication between the multiple terminals, each of which is first registered and performs encryption and decryption by using an identical security key, in such a manner as to allow an algorithm for generating a new security key to be identical.

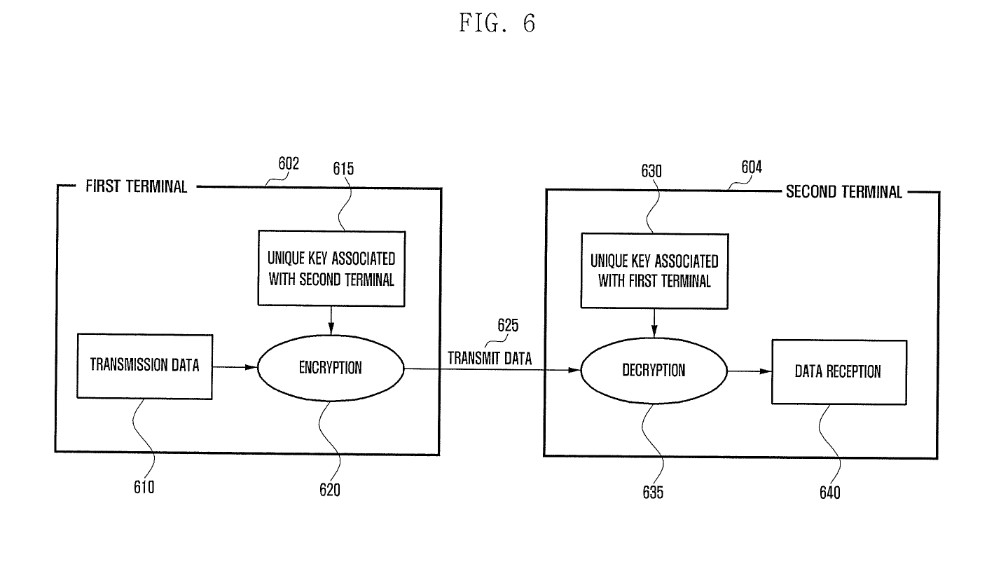

FIG. 6 is a flowchart illustrating a method for applying encryption and decryption wnen data is transmitted and received between terminals, according to an embodiment of the present disclosure.

Referring to FIG. 6, in an embodiment of the present disclosure, a first terminal 602 can transmit transmission data 610 to a second terminal 604. In a previous step, the first terminal 602 and the second terminal 604 can exchange, with each other, and can store one or more of a security key, a fixed time point and a cycle time, which are to be used when the first terminal 602 transmits and receives data to/from the second terminal 604. When the cycle time elapses, each of the first terminal 602 and the second terminal 604 can update the security key. As described above, each of the first terminal 602 and the second terminal 604 can store the security key to be used during transmission and reception of data. The first terminal 602 can store a security key 615 associated with the second terminal 604, and the second terminal 604 can store a security key 630 associated with the first terminal 602. The security keys can be updated by an identical algorithm and the updated security keys can be maintained. According to an embodiment of the present disclosure, when the security keys are updated, the previous security keys can be stored.

The first terminal 602 can perform encryption 620 in order to transmit the transmission data 610. For the encryption 620, the security key 615 associated with the second terminal 604 can be used, and one or more of the algorithms described in this specification can be used as encryption algorithms. As described above, the first terminal 602 performs encryption during data transmission, according to the configuration of a security key, which has been configured when the second terminal 604 has been added to a list, without a separate setting by a user during data transmission. Accordingly, there is a feature such that a security performance can be improved without an increase in user complexity.

The first terminal 602 can transmit the encrypted data to the second terminal 604. During data transmission 625, the first terminal 602 can further include additional information in the data subjected to encryption 620, and the additional information can include an algorithm used for the encryption and time information on performing the encryption.

The second terminal 604 can perform decryption 635 on the received data indicated by reference numeral 625. In an embodiment of the present disclosure, the second terminal 604 can perform the decryption 635 by using the security key 630 associated with the first terminal 602, and the security key 630 associated with the first terminal 602 has a feature in that it can be periodically updated. In the case of the decryption 635, the second terminal 604 can perform decryption based on the encryption algorithm of the received data and the time information on performing the encryption. More particularly, in an embodiment of the present disclosure, a security key associated with a counterpart terminal, which is stored in each terminal, is updated whenever a cycle time elapses, and thus a security key to be applied can be determined based on the encryption time information. Alternatively, according to an embodiment of the present disclosure, decryption can be performed by using a method in which decryption is attempted by using the latest security key and decryption is performed by using a security key used in the previous cycle when the decryption fails. When the decryption is successful, the second terminal 604 can successfully receive data as indicated by reference numeral 640.

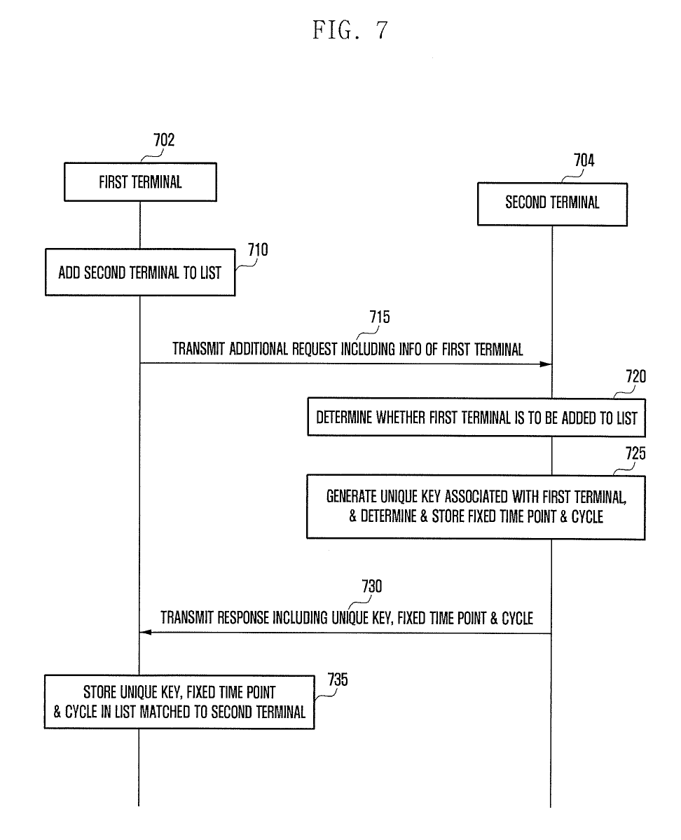

FIG. 7 is a signal flow diagram illustrating a method for configuring a security key between terminals according to another embodiment of the present disclosure.

Referring to FIG. 7, in another embodiment of the present disclosure, each of a first terminal 702 and a second terminal 704 can store a security key associated with a counterpart terminal.

In step 710, the first terminal 702 can add the second terminal 704 to a list. According to another embodiment of the present disclosure, the list can have a concept identical to that of an address book. When the first terminal 702 transmits and receives data to/from the second terminal 704 by using a particular application, the list can be a user list of the particular application. The particular application can include an application providing an RCS.

In step 715, the first terminal 702 can transmit an additional request including information of the first terminal 702, to the second terminal 704.

In step 720, the second terminal 704 can determine whether the first terminal 702 is to be added to a list, based on the request received in step 715. More specifically, the determination can be made according to an input by a user of the second terminal 704.

When it is determined that the first terminal 702 is added to the list, in step 725, the second terminal 704 can generate a security key to be used when the second terminal 704 transmits and receives data to/from the first terminal 702, and can determine and store one or more of a fixed time point and a cycle time.

In step 730, the second terminal 704 can transmit a response, which includes one or more of the multiple pieces of information generated or determined in step 725, to the first terminal 702.

In step 735, the first terminal 702 can store one or more of the multiple pieces of information received in step 730, in the list matched to the second terminal 704.

Thereafter, data can be encrypted and decrypted by using the security key when data is transmitted and received between the first terminal 702 and the second terminal 704, and the security key can be updated based on the fixed time point and the cycle time.

Meanwhile, although exemplary embodiments of the present disclosure have been shown and described in this specification and the drawings, they are used in general sense in order to easily explain technical contents of the present disclosure, and to help comprehension of the present disclosure, and are not intended to limit the scope of the present disclosure. It is obvious to those skilled in the art to which the present disclosure pertains that other modified embodiments on the basis of the spirits of the present disclosure besides the embodiments disclosed herein can be carried out.

According to embodiments of the present disclosure, a security key is configured during communication between terminals, the security key is updated without separate communication between the terminals, and encryption and decryption are performed during transmission and reception of data. Therefore, security can be secured at relatively low complexity during the transmission and reception of data between the terminals.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting and receiving data by a terminal, the method comprising:
determining a security key to be used when the terminal transmits data to and receives data from another terminal;
determining information for updating the security key;
transmitting a signal including information on the security key and information for updating the security key, to the another terminal; and
encrypting data to be transmitted to the another terminal or decrypting data received from the another terminal based on the security key.

2. The method of claim 1, wherein the determining the information for updating the security key comprises determining information including at least one of a reference time point and an update cycle time.

3. The method of claim 2, further comprising:
updating the security key when the update cycle time elapses from the reference time point.

4. The method of claim 3, wherein the decrypting the data received from the another terminal comprises:
decrypting the data received from the another terminal by using the updated security key, and attempting decryption by using the security key before being updated when the decryption fails.

5. The method of claim 3, further comprising:
transmitting, to the another terminal, information including one or more of the encrypted data, an algorithm used for the encryption, and a time on performing the encryption.

6. The method of claim 5, wherein the encrypting the data to be transmitted to the another terminal comprises selecting one of security keys before being updated based on the time on performing the encryption.

7. The method of claim 6, wherein the decrypting the data received from the another terminal comprises decrypting the data received from the another terminal by using the selected security.

8. The method of claim 2, wherein the reference time point is determined based on time information on generating the security key to be used when the terminal transmits and receives the data to/from the another terminal.

9. The method of claim 1, wherein the determining the security key comprises determining the security key based on information on a time point of determining the security key,

10. The method of claim 9, wherein the information on the security key includes the information on the time point of determining the security key.

11. A terminal for transmitting and receiving data, the terminal comprising:
a transceiver configured to transmit data to and receive data from another terminal; and
a controller configured to:
control the transceiver;
determine a security key to be used when the terminal transmits and receives data to/from a another terminal;
determine information for updating the security key;
transmit a signal including information on the security key and information for updating the security key to the another terminal; and
encrypt data to be transmitted to the another terminal or decrypt data received from the another terminal, using the security key.

12. The terminal of claim 11, wherein the controller is configured to determine at least one of a reference time point and an update cycle time.

13. The terminal of claim 12, wherein the controller is configured to update the security key when the update cycle time elapses from the reference time point.

14. The terminal of claim 12, wherein the controller is configured to:
decrypt the data received from the another terminal by using the updated security key; and
attempt decryption by using the security key before being updated when the decryption fails.

15. The terminal of claim 13, wherein the controller is configured to transmit, to the another terminal, information including one or more of the encrypted data, an algorithm used for the encryption, and a time on performing the encryption.

16. The terminal of claim 15, wherein the controller is configured to:
select one of updated security keys before being updated based on the time of performing the encryption.

17. The terminal of claim 16, wherein the controller is configured to:
decrypt the data received from the another terminal by using the updated selected security.

18. The terminal of claim 12, wherein the reference time point is determined based on a time for generating the security key to be used when the terminal transmits and receives the data to/from the another terminal.

19. The terminal of claim 11, wherein the controller is configured to determine the security key based on information on a time point of determining the security key, and

20. The terminal of claim 11, wherein the information on the security key includes the information on a time point of determining the security key.
